(19) United States
(12) Patent Application Publication
(10) Pub. No.: US 2008/0038081 A1
(43) Pub. Date: Feb. 14, 2008

(54) Linch pin having secondary retaining engaging means

(76) Inventor: Daron G. Davis, Versailles, KY (US)

Correspondence Address: Mark L. Davis, P.O. Box 9293, Gray, TN, 37615-9293, US

(21) Appl. No.: 11/483,813

(22) Filed: Jul. 10, 2006

(51) Int. Cl. F16B 39/04

(52) U.S. Cl. 411/213

(57) ABSTRACT

A linch pin for retaining a hitch pin in engagement. The linch pin has a top portion with primary retaining member; a body portion connected to the primary retaining member and having a distal bottom portion wherein the distal bottom portion has a means for engaging a secondary retaining member to prevent the linch pin from inadvertently disengaging from the hitch pin.

### FIELD OF THE INVENTION

The present invention relates to an improved linch pin and in particular to a linch pin having a means for receiving a removable secondary retaining member.

### BACKGROUND OF THE INVENTION

Linch pins are commonly used on equipment throughout the farming, lawn service and construction trades, and particularly are used as a way for quickly securing a hitch pin, retaining bolt or other retaining pin member. For example, in the area of farming, hitch pins are used for connecting a driven or drawn device or implement to a towing or driving vehicle. A farmer normally has a number of different implements which must be connected to either a front loader or rear hitch of a tractor. Typically this equipment is attached to the tractor by mating the lifting mechanism with the clevis of implement. A tractor hitch is well known and typically has two laterally-spaced lower links universally mounted on the rear end of a tractor frame. The lower links are capable of being raised and lowered by lift rods connected to a lift arm that in turn are connected to the respective ends of a rock shaft. The rock shaft is operated by a power lift mechanism housed within a rear portion of the tractor's transmission. At the end of each lower link is an eyelet. When attaching the implement to the tractor, the holes in the clevis are aligned with the lower link eyelets. A hitch pin is then inserted through the implement clevis and lower link eyelets of the lifting mechanism.

To ensure that the lifting mechanism and the implement clevis remain engaged, the hitch pin typically has an annular hole bored in one end for receiving a linch pin. Typically, such linch pins have a straight body member, a widened head portion, and a rotatable spring-tensioning ring connected to the head. When used, the rotatable spring-tensioning ring is placed in an upright position, allowing the straight body member to be inserted through the bore of the hitch pin. To retain or lock the linch pin in the hitch pin bore, the spring-tensioning ring is flipped downward. As one would expect, the only thing holding the linch pin in the hitch pin bore is the tension exerted by the spring-tensioning ring on the linch pin straight body member. The tension in the ring cannot be so little that the ring freely rotates from the downward locked position to the upright removing position lest the linch pin vibrate out or drop from the hitch pin; nor can the tension in the ring be so great that the ring is very difficult to rotate for removal. Thus, many of these type of linch pins are lost or dislodged from the hitch pin during use, which may result in the equipment becoming partially or completely disengaged from the lower link arms of the tractor.

The need to prevent dislodgment of a linch pin from the bore in the hitch pin has usually been addressed by increasing tension on the rotatable spring-tensioning ring which (tightly engages outside surface of the straight body member to prevent such dislodgment. However, as is often the case, the linch pin is a part of a combination of very sturdy elements, the pin's somewhat flexible portions are sufficiently resistant to flexing that the pin must be hammered or otherwise very forcefully set into its operative position in the hitch pin. Under such conditions, the linch pin also requires hammering or other forceful measures to remove it from the bore when desired.

Also, some prior linch pins are provided with a straight, double shank portion with extremity barbs to lock the pin in place. With this arrangement, there is considerable difficulty in releasing the barbs to enable the pin to be removed from the bolt.

Another type of linch pin is disclosed in U.S. Pat. No. 3,975,979. The pin has a serpentine shape extending loosely through the bore in a bolt. The serpentine shape serves to oppose sliding of a collar or the like from the bolt and permits easy sliding of the pin into the bore while opposing being dislodged from the bolt.

Accordingly, there is still a need for a linch pin that is easily inserted and removed and that resists unintentional dislodgment from the hitch pin bore.

### SUMMARY OF THE INVENTION

The present invention is a linch pin for securing a hitch pin or other type of retaining device having a bore in at least one end for receiving the linch pin. The linch pin has a top portion with a first retaining member, a straight body member connected to the top portion, and a distal bottom portion. The bottom portion includes a means for retaining a second, removable retaining member.

It is an object of the present invention to provide a linch pin which may easily be inserted through a transverse bore in a hitch pin, bolt or other similar retaining device without the use of any tool and which may also be easily removed from the hitch pin bore while not being subject to accidental, unintentional dislodgment from the hitch pin bore.

These and other objects and advantages of the present invention will become more apparent to those skilled in the art in view of the following description and the accompanying drawings wherein like parts and objects in the several views have similar reference numerals. It is to be understood that the inventive concept is not to be considered limited to the constructions disclosed herein but instead by the scope of the appended claims.

### BRIEF DESCRIPTION OF THE DRAWINGS

FIG. 1 is an elevational view of a linch pin according to a first embodiment of the invention, illustrating the retaining means on the side of the linch pin and showing a general association with a secondary retaining means.

FIG. 2 is an elevational view of a linch pin according to a second embodiment of the invention illustrating the retaining means on the front of the linch pin.

FIG. 3 is an elevational view of a linch pin according to a third embodiment of the invention illustrating a plurality of retaining means generally at right angles to each other.

### DETAILED DESCRIPTION OF THE INVENTION

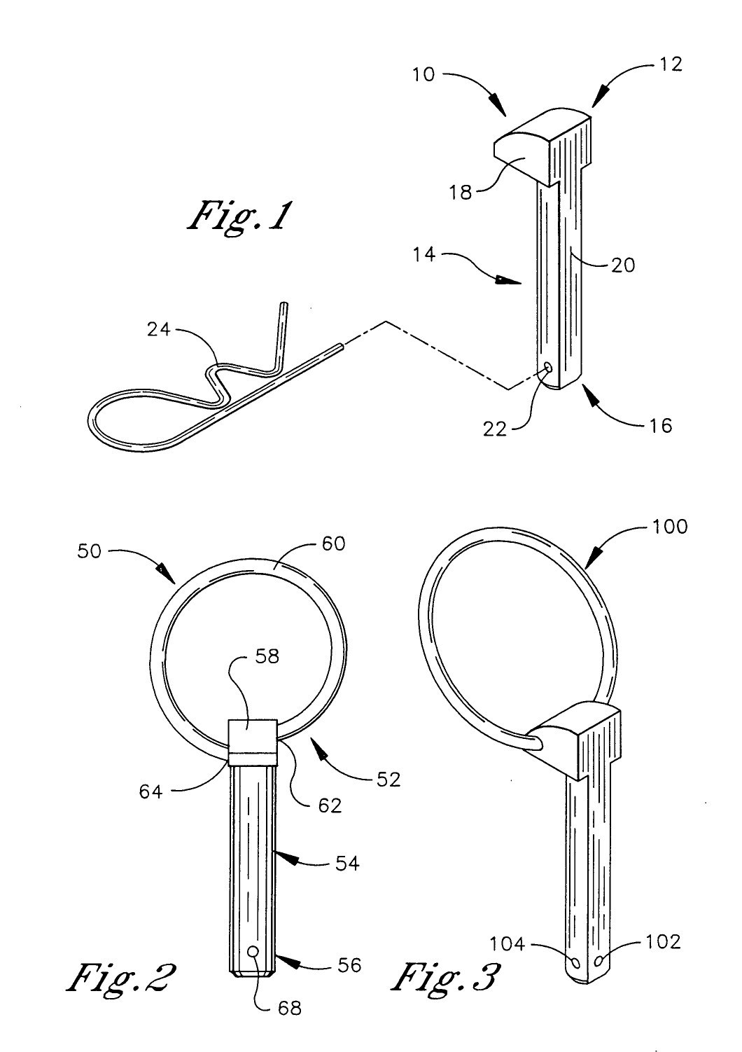

Referring to FIG. 1 a first embodiment is shown as linch pin 10. The linch pin is typically formed of sturdy rod stock of malleable iron. The linch pin 10 has a top portion 12, a straight body portion 14 connected to the top portion with a distal bottom portion 16. The top portion 12 includes a primary retaining member 18 illustrated as widened head member. The primary retaining member 18 functions as a stop for the linch pin 10 and generally abuts one end of a hitch pin bore when in use.

Connected to the primary retaining member or head member 18 is the straight body portion 14. The straight body member 14 is appropriately sized, in length and width, for a predetermined use. That is, hitch pins of different diameters will have a bore that is respectively sized to accommodate a respectively sized linch pin 10. The straight body member 14 may be cylindrical or, as illustrated in FIG. 1, include a flattened back side 20 that facilitates easy insertion and removal of the linch pin 10 from the hitch pin.

The straight body portion 14 of the linch pin 10 also includes a distal bottom portion 16. The bottom portion 16 includes an engaging means 22 for engaging a secondary retaining member 24. The engaging means 22 may be any means known for engaging a secondary retaining member 24 such as a transverse bore through the bottom portion, or a necked down portion having a collar (not shown). The engaging means 22 is appropriately sized so that the secondary retaining member 24 may be easily inserted or removed from engaging means 22. When the engaging means 22 is a transverse bore extending through the bottom portion 16, the bore's relative diameter is from about 25 to about 95% of the bottom portion diameter, and preferably is from about 25 to about 50% of the bottom portion diameter.

Although not necessarily part of the present invention, for the sake of completeness, the secondary retaining member 24 may be anything known to those skilled in the art for engaging the engaging means 22, including, but not limited to, split pins; cotter pins; wire; split rings such as those used in key rings; and the like. Desirably, the secondary retaining member 24 should be of the type and design that will resist inadvertent removal from the engaging means 22.

Referring now to FIG. 2, a second embodiment of the linch pin 50 is illustrated having has a top portion 52, a straight body portion 54 connected to the top portion with a distal bottom portion 56. The top portion 52 further includes a primary retaining member 58. The primary retaining member 58 is illustrated as widened head member. The primary retaining member 58 functions as a stop or for the linch pin 50 and generally abuts one end of a hitch pin bore when in use. Attached to the widened head member 58 is a spring clip 60. The spring clip 60 has a first end 62 and a second end 64 that are respectfully attached to the widened head member 58 by mating with a pair of opposing holes that are slightly off the longitudinal axis from each other. This “off center” positioning of the first and second ends, 62 and 64 respectively, provides the tension for locking the spring clip 60 in an upward position or downward position.

Connected to the head member 58 is the straight body member 54 similar to that described above for the first embodiment 10.

The distal bottom portion 56 of the linch pin 50 includes an engaging means 68 that is similar to the engaging means 22 described above, except that the axis is rotated 90 degrees so that the transverse bore 68 extends from the face to the back instead of from side to side. The diameter of the transverse bore 68 extending through the bottom portion 56 is from about 25 to about 95% of the bottom portion diameter, and preferably is from about 25 to about 50% of the bottom portion diameter.

Referring to FIG. 3, a third embodiment of the linch pin 100 is illustrated. Linch pin 100 is similar to the linch pin illustrated in FIG. 2 described above, with the additional feature that the engaging means comprises a pair of transverse bores 102 and 104 that extend from the face to the back and from side to side, respectively.

For use, the secondary retaining member is disengaged from the engaging means (shown as 22, 68, 102 and 104 in the various figures of drawings) and the linch pin is inserted into the hitch pin's bore. The secondary retaining member is then re-engaged with the engaging means to securely capture the linch pin in the hitch pin's bore. Advantageously, the linch pin is free to move which also allows the hitch pin to rotate as external frictional forces are exerted on the hitch pin without affecting the linch pin engagement.

Advantageously, the likelihood of the linch pin of the present invention to drop out of hitch pin's bore when the hitch pin is rotated approximately 180 degrees is completely eliminated.

Another advantage of the present invention is that there is no need for the spring ring or clip since the widened head member 18 and 58 acts as a stop at one end and the secondary retaining member 24, such as a split pin, cotter pin, or split ring functions as a second stop on the opposing end of the linch pin.

Yet another advantage of the present invention is if a spring ring or clip is utilized, as shown in FIGS. 2 and 3, the amount of tension exerted by the ring may be significantly reduced or even possibly eliminated so that the ring functions more as a means for easy placement and removal instead of retaining the linch pin in engagement as is required by the prior art. Thus, metallic materials of construction for the spring ring or clip may be replaced by a resilient polymeric material of the type known to those skilled in the polymer arts.

Yet another advantage of the present invention is a simplified manufacturing process requiring only an axial hole boring in the distal end for receiving the secondary retaining means. Eliminating the complex boring of “off-center” holes for receiving the spring ring.

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

I claim:

1. A linch pin comprising:
a. a top portion with primary retaining member;
b. a body portion connected to the top portion; and
c. a distal bottom portion connected to the body portion comprising a means for engaging a secondary retaining member.

2. The linch pin of claim 1 wherein said primary retaining member is a widened head member.

3. The linch pin of claim 2 wherein the widened head member comprises a bore hole.

4. The linch pin of claim 3 wherein the bore hole extend through the widened head member.

5. The linch pin of claim 2 wherein the widened head member comprises a pair of opposing bore holes that are slightly off a longitudinal axis from each other.

6. The linch pin of claim 4 further comprising a spring clip, wherein the spring clip includes a first end and a second end that are attached to the widened head member by mating the ends with the bore hole.

7. The linch pin of claim 5 further comprising a spring clip, wherein the spring clip includes a first end and a second end that are attached to the widened head member by mating the ends with the pair of opposing bore holes that are slightly off a longitudinal axis from each other.

8. The linch pin of claim 1 wherein the a body portion is cylindrical.

9. The linch pin of claim 8 wherein the a body portion has a flattened surface.

10. The linch pin of claim 1 wherein the means for engaging a secondary retaining member is a transverse bore through the bottom portion of the linch pin.

11. The linch pin of claim 1 wherein the means for engaging a secondary retaining member is a plurality of transverse bores through the bottom portion of the linch pin.

12. A linch pin comprising, in combination,
a. a top portion comprising a widened head member with a pair of opposing bore holes that are slightly off a longitudinal axis from each other; a body portion connected to the widened head member and having a distal end; and a spring clip having a first end and a second end wherein the ends are engaged with the pair of opposing bore holes, and a means for engaging a secondary retaining member in the distal end; and
b. a secondary retaining member.

13. The linch pin of claim 12 wherein the means for engaging a secondary retaining member is a transverse bore through the bottom portion of the linch pin.

14. The linch pin of claim 13 wherein means for engaging a secondary retaining member is a plurality of transverse bores through the bottom portion of the linch pin.

15. The linch pin of claim 12 wherein the secondary retaining member is selected from a split pin, a cotter pin, or a split ring.
